(19) United States
(12) Patent Application Publication
(10) Pub. No.: US 2005/0078472 A1
(43) Pub. Date: Apr. 14, 2005

(54) Illuminated wine chiller

(76) Inventor: Nicolai Wiest, Frankfurt am Main (DE)

Correspondence Address: GOLDSTEIN LAW OFFICES, P.C., 2071 CLOVE ROAD - 204, STATEN ISLAND, NY, 10304, US

(21) Appl. No.: 10/684,728

(22) Filed: Oct. 14, 2003

(51) Int. Cl. F21V 33/00

(52) U.S. Cl. 362/101

(57) ABSTRACT

An illuminated wine chiller, having a substantially transparent shell having an interior cavity extending downwardly for supporting a bottle of wine in a vertical position while surrounded by ice. The wine chiller has an illumination source within the shell for creating colored light and causing the shell to glow. The illumination source allows the user to vary the color of the illumination light and can automatically vary the color of the illumination light over time.

### BACKGROUND OF THE INVENTION

The invention relates to an illuminated wine chiller. More particularly, the invention relates to a wine chiller having a translucent housing that is selectively illuminated from within.

Champagne, and select wines are best served chilled. Accordingly, refrigeration devices are often employed to keep such wine at the proper temperature prior to serving. While the wine is being served and until the bottle is finished, however, it is also preferable to keep the wine chilled. It is inconvenient, however, to repeatedly return the bottle to the refrigerator between pouring.

A wine chiller is often used to both keep the wine at a cooled temperature and to keep the wine conveniently available. Conventionally provided in the form of a “bucket”, the wine chiller provides an open-top container that is capable of simultaneously holding a bottle of wine and holding a quantity of ice to sufficient to lower the temperature of the wine as needed, and to keep the wine chilled.

The presence of a bottle of wine or champagne is often indicative of celebrations, good times, and the “good life”. In many cases, wine is served in fancy restaurants and stylish nightclubs. Most wine chillers, however, have a boring and uninteresting appearance. What is desired is a wine chiller that has an interesting, stylish appearance that complements high-class, modern surroundings.

While these units may be suitable for the particular purpose employed, or for general use, they would not be as suitable for the purposes of the present invention as disclosed hereafter.

### SUMMARY OF THE INVENTION

It is an object of the invention to produce a wine chiller that is visually appealing. Accordingly, the wine chiller of the present invention has a curvilinear translucent housing that is internally illuminated.

It is a further object of the invention to provide a wine chiller that complements its surroundings. Accordingly, the wine chiller has red, green, and blue LEDs that allow it to illuminate in an infinite variety of colors.

It is yet a further object of the invention to provide a wine chiller that varies in appearance over time. Accordingly, the wine chiller has various user-selectable illumination modes that allow it to change color over time, and produce a variety of lighting effects.

The invention is an illuminated wine chiller, having a substantially transparent shell having a interior cavity extending downwardly for supporting a bottle of wine in a vertical position while surrounded by ice. The wine chiller has an illumination source within the shell for creating colored light and causing the shell to glow. The illumination source allows the user to vary the color of the illumination light and can automatically vary the color of the illumination light over time.

To the accomplishment of the above and related objects the invention may be embodied in the form illustrated in the accompanying drawings. Attention is called to the fact, however, that the drawings are illustrative only. Variations are contemplated as being part of the invention, limited only by the scope of the claims.

### BRIEF DESCRIPTION OF THE DRAWINGS

In the drawings, like elements are depicted by like reference numerals. The drawings are briefly described as follows.

FIG. 1 is a diagrammatic perspective view, illustrating a wine chiller according to the present invention, and a remote control that allows a user to control its operation.

FIG. 2 is a block diagram, illustrating functional interaction between electronic components of the present invention.

### DETAILED DESCRIPTION OF THE PREFERRED EMBODIMENTS

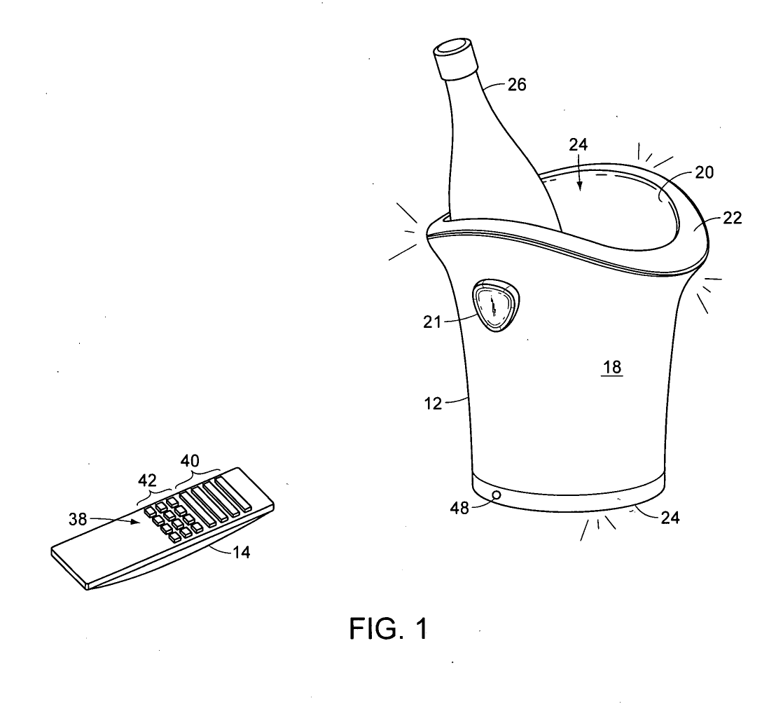

FIG. 1 illustrates a wine chiller 10 having a chiller housing 12, and a remote control 14. The chiller housing 12 has a curvilinear translucent shell 16, including an outer surface 18, an inner surface 20, a top surface 22, and a bottom 24. The bottom surface 24 is substantially flat so as to allow the wine chiller to rest upon a horizontal surface. The housing 12 is open at the top surface 22 and defines an interior cavity 24 downwardly therefrom. The interior cavity is sized to allow a standard wine bottle 26 to rest vertically therein against the inner surface 20 and to allow a plurality of ice to extend therearound to chill said wine bottle 26. The shell 16 is substantially hollow between the inner surface 20 and outer surface 18, is waterproof, and is preferably made of a semi-transparent frosted plastic or glass. In the configuration as shown, a pair of knob like handles 21 are provided on opposite sides of the outer surface 18. It should be noted that by other embodiments of the invention, the wine chiller housing 12 may contain an internal refrigeration unit to effect active chilling of the bottle 26.

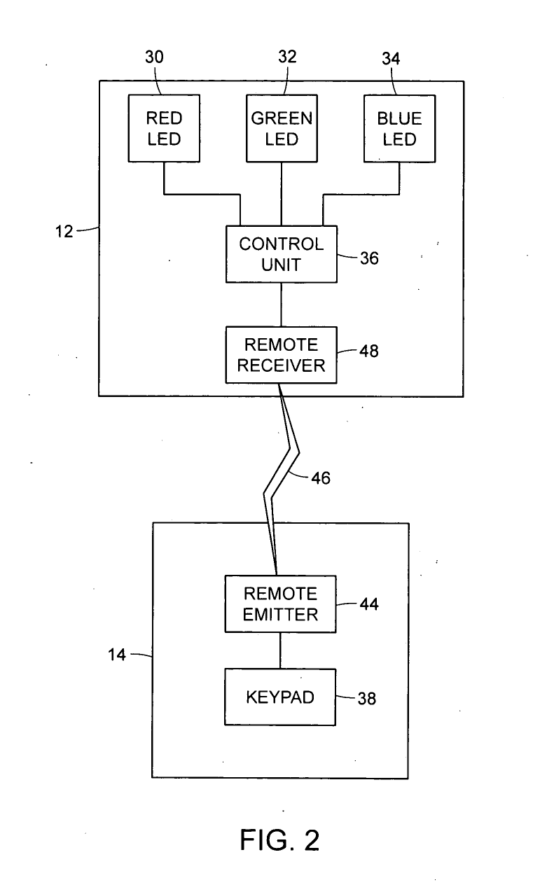

Referring to FIG. 2, a red LED 30, a green LED 32, and a blue LED 34 form an illumination source located within the housing 12 between the inner surface 18 and outer surface 20 to selectively cause the translucent shell 16 to glow with illuminated light. The red LED 30, green LED 32, and red LED 34 are selectively illuminated by a control unit 36 within the housing 12. In particular, the intensity of each LED 30, 32, 34 is precisely and individually determined by the control unit 36. As a result, a nearly infinite variety of illuminated light colors can be obtained by controlling the additive mixture of red, green, and blue light produced by the LEDs 30, 32, 34. The illumination source can be controlled in a variety of color changing modes wherein the intensity of the LEDs are individually varied in intensity by the control unit with subtle changes to obtain gradual changes in color. The illumination source is preferably powered from a rechargeable power source located within the housing 12.

To facilitate user control of the illuminated light colors, the remote control 14 has a keypad 38 that may have rocker switches 40 that allow each color to be individually increased or decreased in intensity, and allow speed control for automatic color changing modes. The keypad 38 may also have a plurality of color mode selection switches 42 that allow the user to select various color changing modes, and to store colors that have been manually created using the rocker switches 40.

The remote control has an infrared emitter 44 that transmits remote command signals 46. The remote command signals 46 are preferably RF signals. The chiller housing 12 has a remote receiver 48 that receives the remote command signals 46, communicates them to the control unit 36, and thereby provides appropriate control over the LEDs 30, 32, 34.

In conclusion, herein is presented an wine chiller capable of illuminating in a variety of colors. The invention is illustrated by example in the drawing figures, and throughout the written description. It should be understood that numerous variations are possible, while adhering to the inventive concept. Such variations are contemplated as being a part of the present invention.

1. An illuminated wine chiller, for chilling a bottle of wine, comprising:
a housing, the housing having a substantially translucent shell having an inside surface, an outside surface, a top surface, and an interior cavity extending downward from the top surface, the interior cavity for containing the bottle of wine vertically therein and surrounding the bottle of wine with a quantity of ice; and
an illumination light source, located within the shell, the illumination light source producing light for causing the shell to glow.

2. The illuminated wine chiller as recited in claim 1, wherein the illumination light source is capable of producing illumination light of different colors, to cause the shell to glow in different colors.

3. The illuminated wine chiller as recited in claim 2, wherein the illumination light source has individually controllable red, green, and blue LEDs, such that varying the intensity of the LEDs varies the color of the illumination light emanating from the shell.

4. The illuminated wine chiller as recited in claim 2, further comprising a remote control, the remote control having a keypad, the remote control allowing a user to vary the color of the illumination light using the keypad.

5. An illuminated wine chilling method, for chilling a bottle of wine using ice and using a wine chiller having a substantially translucent shell having an internal illumination source, the shell having an outer surface, a top surface, an interior cavity extending downward from the top surface, an interior surface surrounding the interior cavity, comprising the steps of:
(a) placing the bottle of wine vertically within the interior cavity;
(b) chilling the wine bottle by surrounding the wine bottle with ice by filling the interior cavity with ice; and
(c) illuminating the shell with colored illumination light by activating the internal illumination source.

6. The illuminated wine chilling method as recited in claim 5, wherein the step of illuminating the shell with colored light further comprises controlling the color of the colored illumination light by the user.

7. The illuminated wine chilling method as recited in claim 6, further using a remote control having a keypad, wherein the step of controlling the color of the illumination light further comprises issuing commands by the remote control by the user operating the keypad of the remote control.

8. The illuminated wine chilling method as recited in claim 5, wherein the chiller has a control unit in communication with the illumination source, and wherein the method further comprises the step of automatically changing the color of the illumination light by the control unit.

9. The illuminated wine chilling method as recited in claim 8, wherein the illumination source has individually controllable red, green, and blue LEDs; and wherein the step of changing the color of illumination light further comprises varying the relative intensity of the red, green, and blue LEDs.
